(19) United States
(12) Patent Application Publication
(10) Pub. No.: US 2010/0162201 A1
(43) Pub. Date: Jun. 24, 2010

(54) AUTOMATED MULTI-PLATFORM CONFIGURATION TOOL FOR MASTER DATA MANAGEMENT SYSTEMS USING SECURE SHELL PROTOCOL

(75) Inventors: Tal SHNAIDERMAN, Kiryat-Yam (IL); ODED GOLDSMIDT, Karmiel (IL)

Correspondence Address: SAP_DLG, 7910 IVANHOE AVE., # 325, LA JOLLA, CA, 92037, US

(73) Assignee: SAP AG, Walldorf (DE)

(21) Appl. No.: 12/338,537

(22) Filed: Dec. 18, 2008

(51) Int. Cl. G06F 9/44; G06F 9/445; G06F 15/16; H04L 9/32; G06F 17/30

(52) U.S. Cl. 717/101; 717/126; 717/174; 709/227; 726/6

(57) ABSTRACT

Various embodiments of a method, apparatus and article of manufacture provide an automated multi-platform configuration tool for master data management systems using secure shell protocol.

### FIELD OF THE INVENTION

Embodiments of the invention described herein pertain to the field of computer systems. More particularly, but not by way of limitation, one or more embodiments of the invention enable an automated multi-platform configuration tool for master data management systems using secure shell protocol.

### DESCRIPTION OF THE RELATED ART

Installation and configuration of large, complex software systems are complex processes requiring many steps to be performed correctly. Such systems must be tested on all of the many platforms for which the software is sold. Software testing and verification of large, complex software systems is a time consuming process. During the heat of development, new build versions of such a product may be produced nightly. Test and verification organizations (“T&V”) may be responsible for producing accurate results quickly.

For large, complex software systems such as master data management (MDM) systems, for example, installing the latest build on all the required platforms may take half a day. And yet the next build will be waiting in the morning, perhaps propagating errors of the prior build if that build is not properly tested on all required platforms. Creating a full and correct “install program,” such as those delivered with the final product, for each platform customized for each build is overly burdensome for test and development teams, and thus, at least early on in the testing process test teams may be required to “manually” install each build on each platform each day before beginning the day's testing process. While it is sometimes possible to install only components that have been changed, such a procedure may compromise the quality of the test results.

T&V teams would prefer to have automatic remote installs as a way of quickly and correctly distributing and installing each build from a central source to all test platforms in a known, repeatable and reliable fashion. Over time, complex system T&V groups have found it advantageous to develop their own software tools to automate the rapid installation and configuration of development builds for multiple platforms. Automation of the installation and configuration process is now a preferred solution for performing test installations.

However, creating and maintaining unique installation programs for each build for each platform available for a given MDM solution is cost prohibitive. The installation program may be required to change often to accommodate important change in the system under test. Thus, a single master program with associated project files containing particular information for a given target platform may be preferred. One challenge to this approach, however, is selection of a computer programming language and tool set that is supported on all platforms on which the system under test must be installed.

T&V teams may select a multi-platform computer language such as Java for the job, as Java is designed to execute on any platform. However, tools developed in Java require the target machine to support and have installed a Java Virtual Machine (JVM) program to execute the Java program. Unfortunately, the presence of a JVM merely to support installation of test builds may be undesirable because it may influence or alter test results, may be burdensome for some systems, or a JVM may simply not be readily available for the platform in question. Because of these challenges T&V teams may fall back on less preferred but reliable manual installation of the system under test on various test platforms where automated installation and configuration of the system under test is not practical.

Thus, T&V organizations have a need for a way to quickly, reliably and remotely install a system under test on many platforms from a single program without requiring the target systems to host foreign software such as a JVM just to support the remote installation. In particular, it would be desirable to have automated installation and configuration tool for large and complex software systems such as MDM systems that was developed in Java and would run identically on Windows and various UNIX platforms with no special support software required to run the install on multiple target platforms. A program tool to remotely install and configure an MDM system to execute for test on multiple platforms on which the system may run would be an advance in the art. It would be a further advantage if the tool implemented a known and secure communication protocol available on multiple UNIX implementations.

For at least the limitations described above there is a need for an automated multi-platform configuration tool for master data management systems using secure shell protocol.

### BRIEF SUMMARY OF THE INVENTION

One or more embodiments of the invention enable an automated multi-platform configuration tool for master data management systems using secure shell protocol. To overcome the limitations in the prior art described above, and to overcome other limitations that will become apparent upon reading and understanding the present specification, various embodiments of a method, apparatus and article of manufacture to provide a decision point in a workflow system are described.

Automated project files are generally used to support generic installation programs, creating a consistent and repeatable environment essential for reliable testing. Such automated project files customize the installation for a given platform, allowing changes required for the platform to be insolated in a project file. However, each platform still requires unique project files. Using the classes and methods of the invention, a customized multi-platform application may be created to completely install an MDM program on a UNIX server or other platform from a Windows Client using the tool described. The tool of the invention may allow automated installation, as well as automated execution and test of large, complex software systems under test, such as a MDM system, on a target system from a remote client. In this way, the invention supports the development of platform independent test programs for MDM systems and other similar types of systems.

Thus, a method, apparatus and article of manufacture providing an automated multi-platform configuration tool for master data management systems using secure shell protocol is described. In various embodiments, the tool may take advantage of various multi-platform communication protocols to open communication with and engage the target operating system in supporting installation and configuration processes, providing simple and reliable remote multi-platform installation and configuration capabilities.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an exemplary system architecture for one or more embodiments of the invention.

FIG. 2 illustrates an SSH Log Viewer interface example supporting users of one or more embodiments of the invention.

FIG. 3 illustrates a Java class structure for an implementation of one or more embodiments of the invention.

FIGS. 4A-4D illustrates detailed exemplary Java class fields and methods for implementing the class structure of FIG. 3 in one or more embodiments of the invention.

FIG. 5 illustrates a general-purpose computer system that when programmed with a tool as taught herein may perform the methods of one or more embodiments of the invention.

### DETAILED DESCRIPTION

An automated multi-platform configuration tool for master data management systems using secure shell protocol will now be described. In the following exemplary description numerous specific details are set forth in order to provide a more thorough understanding of embodiments of the invention. It will be apparent, however, to an artisan of ordinary skill that the invention may be practiced without incorporating all aspects of the specific details described herein. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

After considering the following description, those skilled in the art will realize that the teachings of the various embodiments of the invention may be utilized to provide an automated multi-platform configuration tool for master data management systems using secure shell protocol. The tool herein described may be implemented in any one of a number of computer programming languages well known to those of ordinary skill in the art, and thus not detailed herein to avoid obscuring the invention. While the Java language is used to describe implementations of one or more embodiments of the invention, the invention is not limited to implementation in Java, as will be understood by those in the art.

In the follow description, the complex software program under test will be illustrated with references to the SAP MDM system, though those of skill in the art will see that the invention may be useful for installing and/or performing remote automated testing of other MDM systems, as well as other types of complex software systems and applications such as embedded systems, operating systems, other databases, as well as other large application programs whose test and/or installation process are too complex or time consuming to install manually, or where frequent installation or for other reason causes manual installation processes to be less than ideal.

For brevity, the complex software program to be tested will be referred to as the “system under test” or the exemplary “MDM”. An implementation of one or more embodiments of the invention will be referred to as the “installation program” or “test program.” More generally, a program of either type in the spirit of the invention may be referred to as a “tool” or “utility”. For simplicity of description, Java will be used as an exemplary computer language for implementing the installation or test program, though those of skill in the art will understand that the tool of the invention may be implemented in any convenient language. The computer platform upon which the system under test will execute will be referred to as the “target system”. The client computer where installation tool is launched will be referred to as a “source system”. The communication between the source system and target system will be described in terms of Secure Shell (“SSH”) Protocol, however, those of skill in the art will recognize that the choice of SSH is not required to implement the invention, nor is any particular version or flavor of SSH required. Alternative and/or complementary protocols such as MSSH (from the Metropolitan State College of Denver), or zebedee (Linux) or other protocols known to those of skill in the art may be used with the invention. This communication means may be described as a “pipe,” using that term in its broadest common usage.

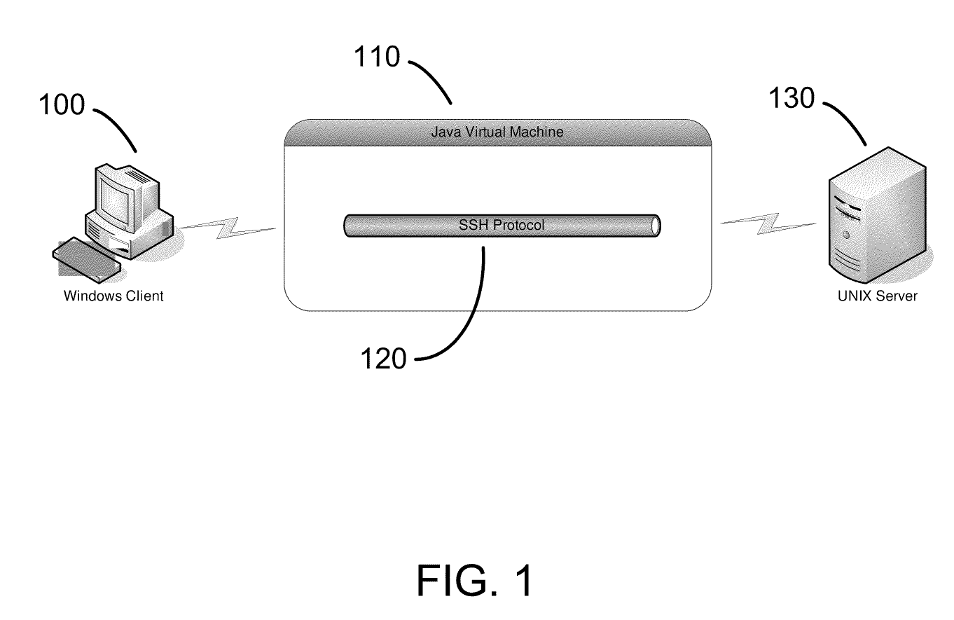

FIG. 1 illustrates an exemplary system architecture for one or more embodiments of the invention. In this embodiment, an exemplary client, Windows Client 100 acts as a source system for the installation and configuration program for remotely installing a build of a complex software program such as a master data management (MDM) system. In one or more embodiments, a test program may be written in Java for Windows Client 100 that will execute on Java Virtual Machine 110. Java Virtual Machine 110 runs on Windows Client 100. The Java installation program may utilize the Secure Shell Protocol (SSH) in one or more embodiments to access exemplary remote computer, UNIX computer 130. In this example, UNIX computer 130 may be a target computer for a complex software system. To better illustrate the invention, an MDM system will be used as an example of a complex software system. More particularly, the SAP MDM system may be used as an example, though it will be clear to one of ordinary skill that the invention is not limited to SAP MDM, or any manufacturer's MDM system, as described above.

Other alternative forms of pipes to connect to the remote system may be chosen that are in keeping with the invention. For example, numerous embodiments of Secure Shell (SSH) client are available for use with one or more embodiments of the invention. For example, the UNIX “xterm” program may be used to connect to the remote system, if that system is a UNIX system. An API-enabled program offering telnet-like functionality for remote sessions to the chosen target system will be in keeping with the spirit of the invention. For example, an API enabled version of “rsh” (UNIX Remote Shell) would be one means to enable the remote connection of the invention. Such programs are freely available as Java beans or other implementations. Additional options for programmatic remote login may be used, including “PuTTY”. PuTTY is a free-ware implementation of SSH for Windows with APIs available for some languages. One or more of these or other options for making a programmatic remote connection to the target system is selected for implementation of the invention. PuTTY includes a Telnet and SSH clients, as well as a command line secure file copy utility, a secure File Transfer Protocol (SFTP), a telnet-only client, a command line interface and a Plink utility, for example. However, PuTTY does not provide some of the functions required to automate a remote installation process.

Where the installation program of the invention is written in Java, a test program developer creating the program may need to create code to bind the Java to a communications protocol such as SSH. When using the freeware application PuTTY, for example, no Java bindings exist. Creating Java bindings for PuTTY was accomplished in one or more embodiments of the invention. Installation and test program developers may also be aware that at this time PuTTY does not provide a binding or class cognizant of the UNIX file system (UFS). Therefore, programmers creating an embodiment of the invention in Java for target systems in UNIX must create a Java File Class Format to access the file system of the target computer.

Automated project files are generally used to support generic installation programs, creating a consistent and repeatable environment essential for reliable testing. Such automated project files customize the installation for a given platform, allowing changes required for the platform to be insolated in a project file. However, each platform still requires unique project files.

Using the classes and methods of the invention, a customized multi-platform application may be created to completely install an MDM program on UNIX server 130 or other platform from Windows Client 100 using the tool of the invention. The tool of the invention may allow automated installation, as well as automated execution and test of large, complex software systems under test, such as a MDM system, on a target system from a remote client. In this way, the invention supports the development of platform independent test programs for MDM systems and other similar types of systems.

Automated project files may still be used with the tools of the invention to support a single platform-generic installation program creating a consistent and repeatable installation program that creates a test environment essential for producing reliable results. Such automated project files may customize the single-platform generic installation program to meet the requirements for each of the target systems, allowing changes required for any particular platform to be insolated in a project file.

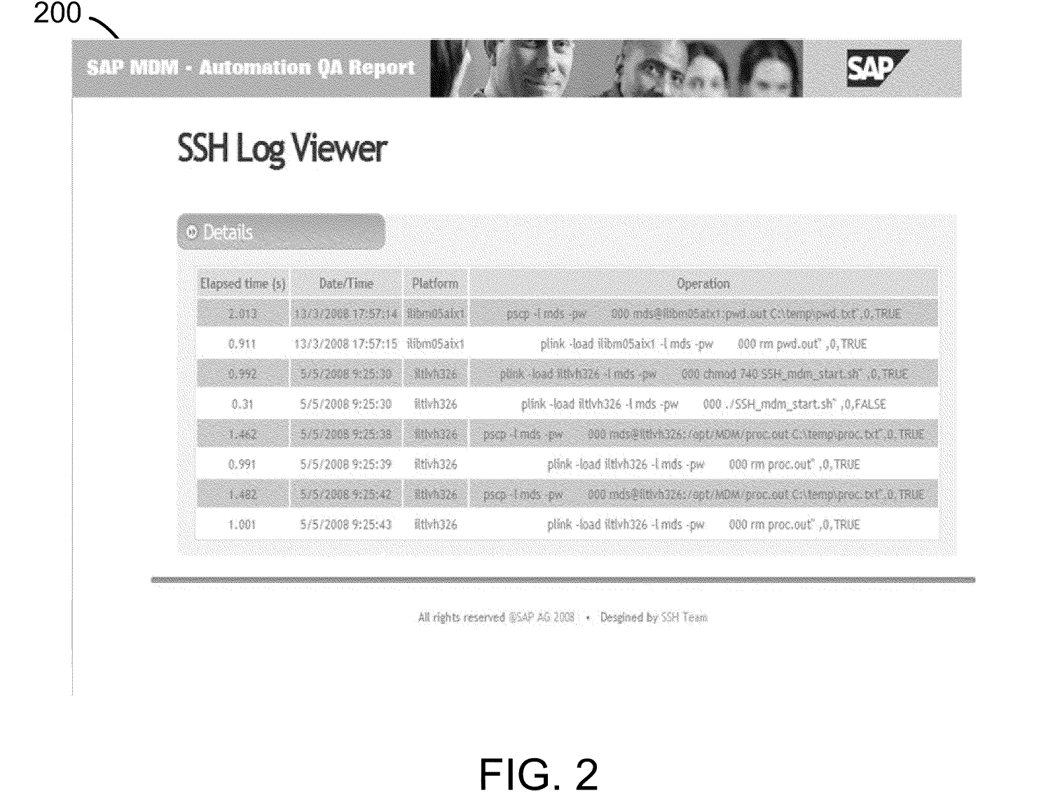

FIG. 2 illustrates an SSH Log Viewer interface 200 as an example of a user interface that may be developed to support users of one or more embodiments of the invention. Viewer 200 provides information on the elapsed time, start time, platform and operation performed by an embodiment of the tool running from a Windows computer to configure a UNIX system.

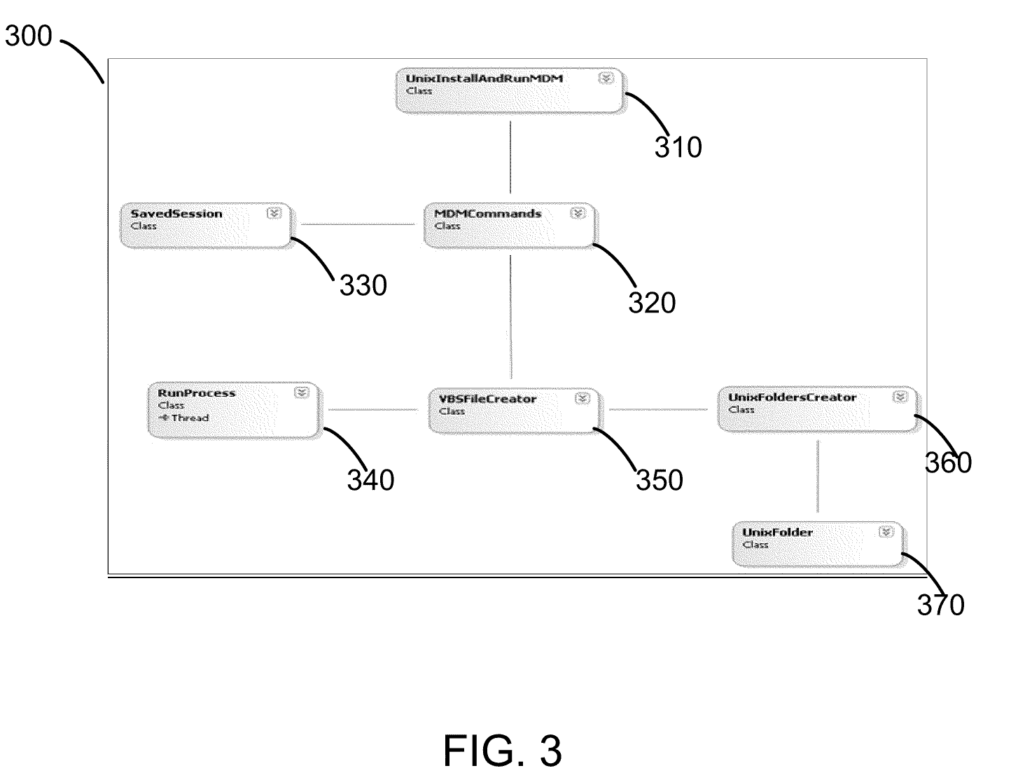

FIG. 3 illustrates a Java class structure 300 for an implementation of one or more embodiments of the invention, in this case, an installation tool embodiment for a UNIX target. Class UnixInstallAndRunMDM 310 may be a parent class to an installation tool embodiment. Subclass MDMCommands 320 may parent two child classes: SavedSession 330 and VBSFileCreator 350. VBSFileCreator 350 may parent two classes: RunProcess 340 and UnixFoldersCreator 360. UnixFoldersCreator 360 may parent child class UnixFolder 370.

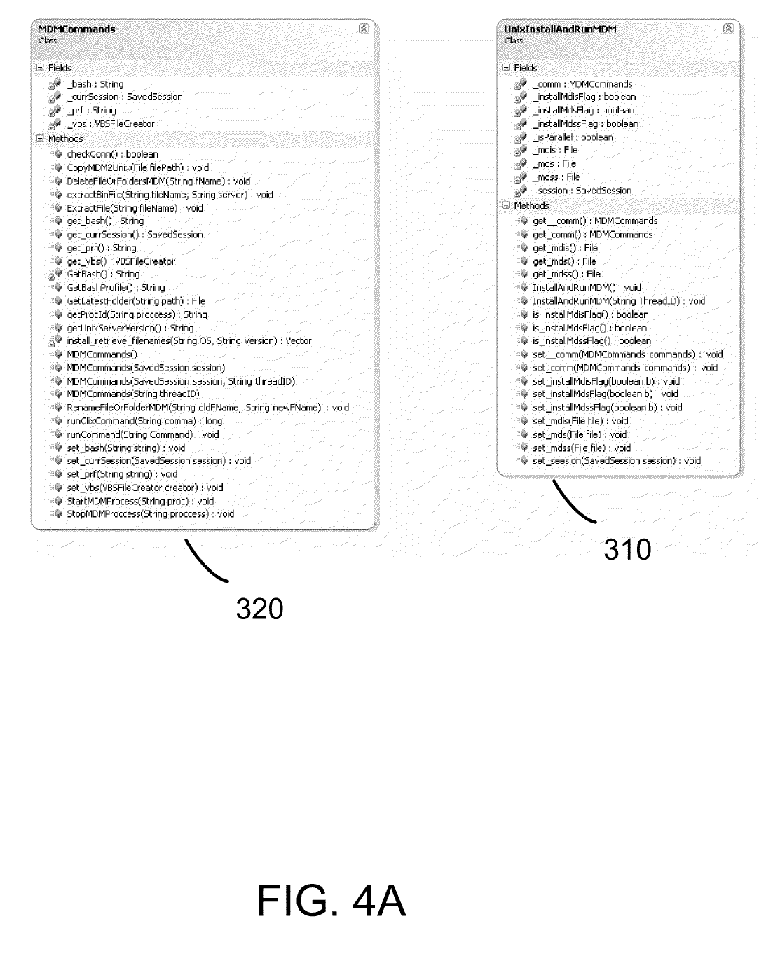

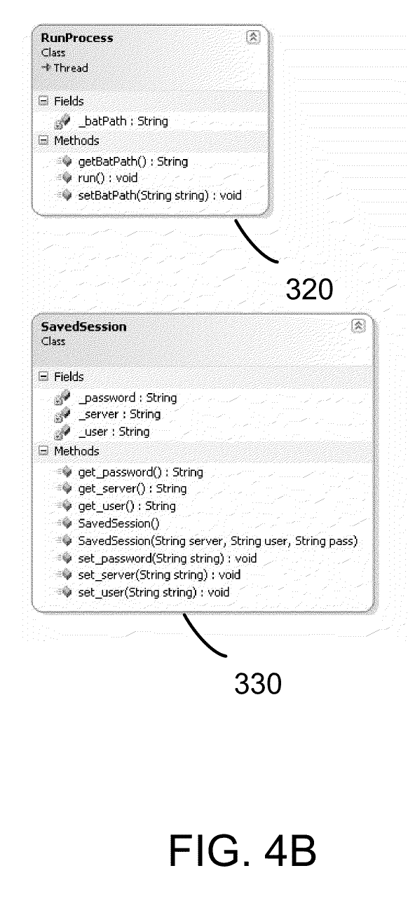

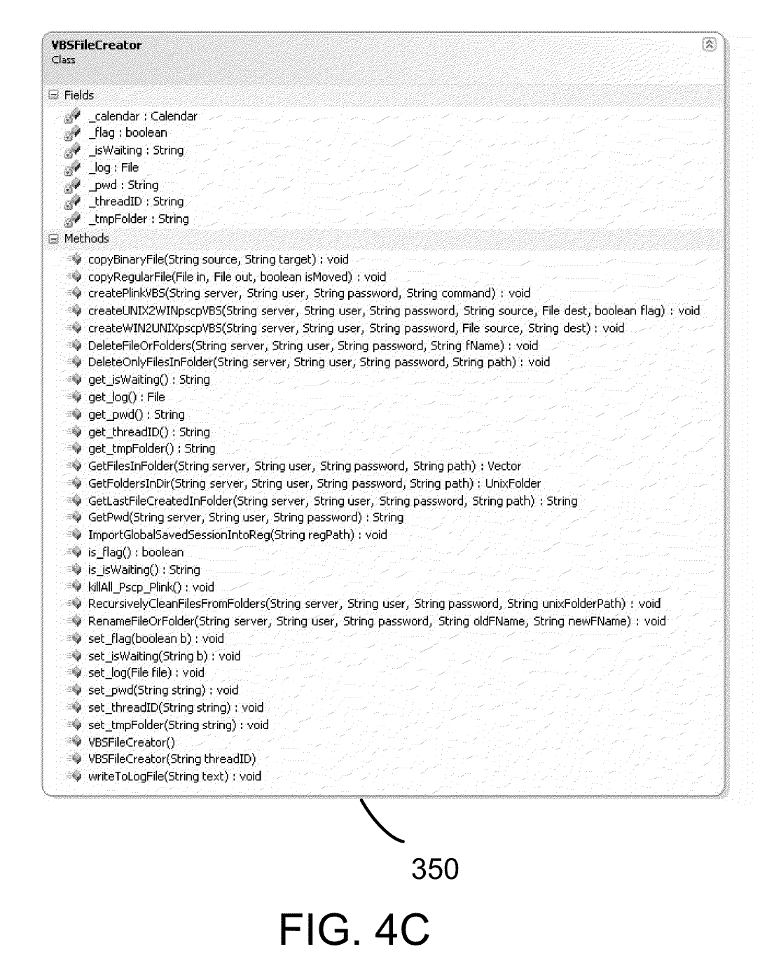

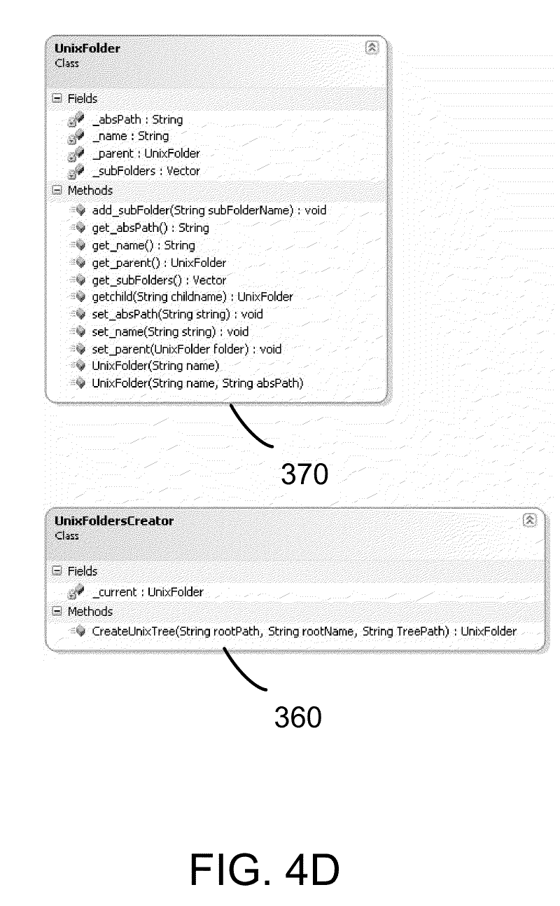

FIGS. 4A-4D illustrates exemplary Java class fields and methods for implementing the class structure of FIG. 3 in one or more embodiments of the invention. FIG. 4A provides detailed classes for UnixInstallAndRunMDM 310 its child MDMCommands 320. UnixInstallAndRunMDM 310 may provide high level functions for the tool, supported by fields and methods to manage tasks and file handles, such as for example, _comm, instantiating the MDMCommands 320 class, as well as Boolean flags, various file handles, and _session to instantiate class SavedSession 340.

MDMCommands 320 provides exemplary fields such as bash (for the “bash” (“Bourne-again”) shell), _currSession for a current session identifier, _prf for storing preferences, and _vbs for instantiating VBSFileCreator 350. UnixInstallAndRunMDM 310 may also support essential high-level methods such as: CopyMDMtoUnix, ExtractBinFile, GetLatestFolder, and StartMDMProcess. The purpose of such methods and fields will be clear to those of skill in the art from these exemplary structures, methods and the labels associated therewith.

FIG. 4B provides example classes SavedSession 330 and RunProcess 340. SavedSession class 330 provides fields and methods to restore a prior session, such as resubmitting a user name and password and knowing which server the session was saved from. RunProcess 340 is able to start a process on the source system.

FIG. 4C illustrates an example class VBSFileCreator 350, which contains fields and methods to create, delete, and manage files and processes for managing files, on the remote target system. Functions such as copying binary files, creating and deleting folders, and other important file system interface functions may be implemented in this class.

FIG. 4D illustrates example classes UnixFoldersCreator 360 and UnixFolder 370. UnixFoldersCreator 360 encapsulates the functions of managing the UNIX file system tree structure, while child class UnixFolder 370 keeps track of the tree structure of the UNIX file system on the target system.

It will be clear to one of skill in the art that the above described installation tool embodiment of the invention may support the following functionality: (1) Manual complete installation of MDM on all varieties of UNIX servers; (2) automated MDM complete installation on UNIX servers; (3) integration between Java based applications and UNIX; (4) Execute UNIX commands from remote Windows server; (5) Stop and Start and MDM services from remote Windows servers; (6) Retrieve the UNIX file system (UFS) data in a Java file class format; and (7) allow automated MDM quality assurance testing on UNIX lab servers. These and other desirable advancements are available from tools implemented using one or more embodiments of the invention.

An application program in the spirit of the tool of the invention may also perform the following steps to implement one or more embodiments of the invention: acquiring a test build of a complex software application; copying said test build to a source directory on a source system; establishing a connection to a target system from said source system; acquiring administrator rights to said target system; creating a user account and a password on said target system using said administrator rights; switching users to said user account; copying said test build from said source system to said target system; installing said test build on said target system, wherein said test build comprises an application program; starting said application server process on said target system; and verifying said application server process execution with said operating system of said target system. These and other desirable advancements are available from tools implemented using one or more embodiments of the invention.

In particular, various embodiments may also implement an application program that may comprise remotely installing a Master Data Management server application by performing steps comprising: configuring the target system by establishing environmental variable settings for the test build on the target system; binding the Master Data Management server to a client library; configuring the Master Data Management server to connect to client software on the source system; connecting to the target system to provide access to establish parameters required for the target system; accessing project files on the source system to establish default server setting for the application server process; and using the connection to backup application configuration files before installing the application program.

Another type of application that may be created using the invention includes remote installation and execution of test programs to verify the operation of a complex software application on a remote UNIX server. The invention may comprise a computer program product further comprising a computer readable medium encoded with computer executable instructions that when executed by a computer may programmatically remotely test a Master Data Management system on a UNIX platform target system from a Windows platform source system, the computer program product performing steps comprising: establishing a connection to a target system running UNIX from a source system running Microsoft Windows; recursively deleting all files from a UNIX folder on the target system to create a clean test environment; copying a test program from the source system to the target system; installing the test program on the target system; executing the test program on the target system; and verifying the test program execution on the target system. Further, the test program may be written in Java where the invention is used to connect the Java application program under test via a pipe as described elsewhere herein. For example, an SSH connection may be used to execute commands remotely on the target from the source system, allowing a single test program to test MDM type systems remotely on multiple platforms. One or more embodiments may keep the results of the execution of a test program in the spirit of the invention in a log file for later examination.

The following tables contain code snippets of Java code from an exemplary implementation of one or more embodiments of the invention. One of ordinary skill in the art will appreciate that these snippets are part of one approach to implementing the invention, and that many alternative approaches are easily discerned that would be in keeping with the spirit of the above disclosed invention.

A complete SAP MDM Installation:

UnixInstallAndRunMDM inst = new UnixInstallAndRunMDM( );
inst.set_seesion(new SavedSession(“ilsun501”,“xcs”,“XXXXXX”));
inst.set_mdis(new File(“C:\\mdm-import-server-5.5.61.62-solaris-
sparc64-CC.tar.Z”));
inst.set_mds(new File(“C:\\mdm-server-5.5.61.62-solaris-sparc64-
CC.tar.Z”));
inst.set_mdss(new File(“C:\\mdm-syndication-server-5.5.61.62-solaris-
sparc64-C.tar.Z”));
inst.InstallAndRunMDM( );
System.out.println(inst.is_installMdisFlag( ));
System.out.println(inst.is_installMdsFlag( ));
System.out.println(inst.is_installMdssFlag( ));

File Operations

VBSFileCreator vbs = new VBSFileCreator( );
vbs.DeleteOnlyFilesInFolder(“ilibm04”,“xcs”,“XXX”,“Temp/test”);
UnixFolder root = vbs.GetFoldersInDir(“ilsun500”,“xcs”,
“XXXXXXX”,“MDS/Archives”);
vbs.createPlinkVBS(“ilmdmp08”,“xcs”,“XXX”,“cd Distributions;
ls -a > Files.out”);
vbs.createUNIX2WINpscpVBS(“ilmdmp08”,“xcs”,“XXX”,“Distribution/
DisTree.out”,new
File(“C:\\DistTree.xml”),true);
vbs.createWIN2UNIXpscpVBS(“ilmdmp08”,“xcs”,“XXX”,new
File(“C:\\Test.class”),“Test.out”);

SAP MDM Operations

VBSFileCreator vbs = new VBSFileCreator( );
vbs.DeleteOnlyFilesInFolder(“ilibm04”,“xcs”,“XXX”,“Temp/test”);
UnixFolder root = vbs.GetFoldersInDir(“ilsun500”,“xcs”,
“XXXXXXX”,“MDS/Archives”);
vbs.createPlinkVBS(“ilmdmp08”,“xcs”,“XXX”,“cd Distributions;
ls -a > Files.out”);
vbs.createUNIX2WINpscpVBS(“ilmdmp08”,“xcs”,“XXX”,“Distributions/
DisTree.out”,new
File(“C:\\DistTree.xml”),true);
vbs.createWIN2UNIXpscpVBS(“ilmdmp08”,“xcs”,“XXX”,
new File(“C:\\Test.class”),“Test.out”);

In various embodiments, the invention may be implemented as a method, apparatus, or article of manufacture using standard “programming and/or engineering techniques to produce software, firmware, hardware, or any combination thereof. The term “article of manufacture” (or alternatively, “computer program product”) as used herein is intended to encompass a computer program accessible from any computer-readable device, carrier or media. In addition, the software in which various embodiments are implemented may be accessible through the transmission medium, for example, from a server over the network. The article of manufacture in which the code is implemented also encompasses transmission media, such as the network transmission line and wireless transmission media. Thus, the article of manufacture also comprises the medium in which the code is embedded. Those skilled in the art will recognize that many modifications may be made to this configuration without departing from the scope of the invention.

Furthermore, embodiments of the invention may be implemented as a program of computer readable instructions and/or computer readable data stored on a computer-readable medium. Programs, data and other information may constitute, but are not limited to, sets of computer instructions, code sequences, configuration information, and other information in any form, format or language usable by a general purpose computer or other processing device, such that when such a computer contains, is programmed with, or has access to the programs, data and other information the general purpose computer is transformed into a machine capable of performing an automated multi-platform configuration tool for master data management systems using secure shell protocol, such as that described above. A computer-readable medium suitable to provide computer readable instructions and/or computer readable data for the methods and processes described herein may be any type of magnetic, optical, or electrical storage medium including a disk, tape, CD, DVD, flash drive, thumb drive, storage card, or any other memory device or other storage medium known to those of skill in the art.

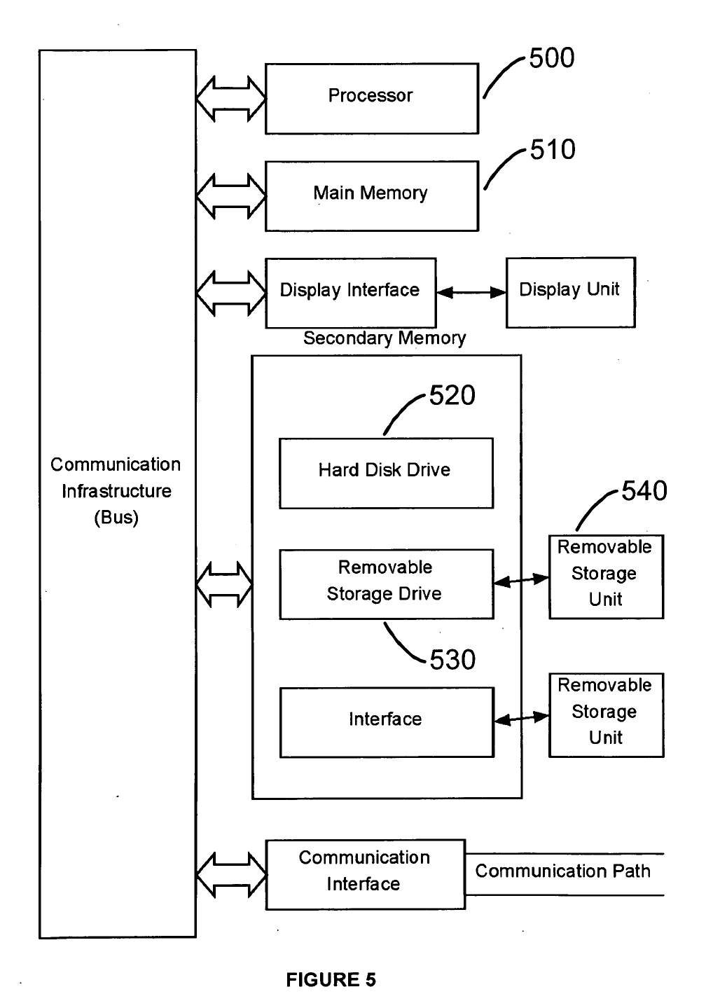

Generally, an embodiment of the invention is tangibly embodied in a computer-readable medium, for example, random access memory or permanent memory such as a compact disc. The embodiment of the tool described may be comprised of computer readable instructions that when executed by processor 500, cause a computer system such as that illustrated in FIG. 5 to perform the tool described herein. Main memory 510 may store the software instructions, data structures, communication packets and other data for any of the operating system, database management system and configuration tool or other programs executing in volatile memory, or stored in non-volatile local or removable memory such as hard disk drive 520, removable storage 530, or remote removable storage 540, or a combination thereof.

While the invention herein disclosed has been described by means of specific embodiments and applications thereof, numerous modifications and variations could be made thereto by those skilled in the art without departing from the scope of the invention set forth in the claims. The foregoing description is therefore considered in all respects to be illustrative and not restrictive. The scope of the invention is indicated by the appended claims, and all changes that come within the meaning and range of equivalents thereof are intended to be embraced therein.

What is claimed is:

1. A computer program product comprising a computer readable medium encoded with computer executable instructions that when executed by a computer programmatically remotely install a Master Data Management system on a UNIX platform target system from a Windows platform source system, said computer program product performing steps comprising:
acquiring a test build of a complex software application;
copying said test build to a source directory on a source system;
establishing a connection to a target system from said source system;
acquiring administrator rights to said target system;
creating a user account and a password on said target system using said administrator rights;
switching users to said user account;
copying said test build from said source system to said target system;
installing said test build on said target system, wherein said test build comprises an application program;
starting said application server process on said target system; and
verifying said application server process execution with said operating system of said target system.

2. The computer program product of claim 1 wherein said application program comprises a Master Data Management server application.

3. The computer program product of claim 1 further comprising configuring said target system by establishing environmental variable settings for said test build on said target system.

4. The computer program product of claim 2 further comprising binding said Master Data Management server to a client library.

5. The computer program product of claim 2 further comprising configuring said Master Data Management server to connect to client software on said source system.

6. The computer program product of claim 1 wherein said connection to said target system provides access to establish parameters required for said target system.

7. The computer program product of claim 1 further comprising accessing project files on said source system to establish default server setting for said application server process.

8. The computer program product of claim 1 further comprising using said connection to backup application configuration files before installing said application program.

9. The computer program product of claim 1 written in Java, further comprising bindings from Java to a UNIX.

10. A computer program product comprising a computer readable medium encoded with computer executable instructions that when executed by a computer programmatically remotely test a Master Data Management system on a UNIX platform target system from a Windows platform source system, said computer program product performing steps comprising:
establishing a connection to a target system running UNIX from a source system running Microsoft Windows;
recursively deleting all files from a UNIX folder on the target system to create a lc copying a test program from said source system to said target system;
installing said test program on said target system;
executing said test program on said target system; and
verifying said test program execution on said target system.

11. The computer program product of claim 10, wherein said test program is written in Java.

12. The computer program product of claim 10, wherein said test program execution results in a test program log.
